(19) United States
(12) Patent Application Publication
(10) Pub. No.: US 2006/0273623 A1
(43) Pub. Date: Dec. 7, 2006

(54) Open air elevated deck bus

(76) Inventor: Ronald J. Romano, Manalapan, NJ (US)

Correspondence Address: PETER L. BREWER;BAKER, DONELSON, BEARMAN, CALDWELL & BERKOWITZ, 165 MADISON AVENUE, SUITE 2000, MEMPHIS, TN, 38103, US

(21) Appl. No.: 11/281,803

(22) Filed: Nov. 17, 2005

Related U.S. Application Data
(60) Provisional application No. 60/687,528, filed on Jun. 3, 2005.

(51) Int. Cl. B62D 47/00

(52) U.S. Cl. 296/178

(57) ABSTRACT

A sightseeing bus is provided. The bus includes a chassis, a single elevated observation deck, a plurality of seats, a stairwell holding a stairway, and a driver's compartment. The observation deck is elevated above the chassis with a portion of the elevated deck disposed above the driver's compartment. The plurality of seats are arranged upon the observation deck. The stairway has its lower end disposed at a level at or below the chassis, and the upper end thereof disposed at a level of the observation deck. A method for conducting sightseeing services utilizing the sightseeing bus is also provided.

### STATEMENT OF RELATED APPLICATIONS

The present application claims priority to Provisional Patent Application Ser. No. 80/687,528 filed Jun. 3, 2005. (Confirmation No. 2861.) That application is entitled “Open Air Elevated Deck Bus.” The application is incorporated herein by reference in its entirety.

### BACKGROUND OF THE INVENTION

1. Field of the Invention

The present invention relates to a tour vehicle. More particularly, the invention relates to a commercial transport vehicle configured to permit a plurality of passengers view an area from an elevated position.

2. Description of the Related Art

Multi-passenger vehicles are known. In addition, multi-passenger commercial vehicles such as buses are known. Still further, multi-passenger tour vehicles are known and have been the subject of patents within the United States.

In 1914, U.S. Pat. No. 1,102,602 was issued. This patent discloses a vehicle having an enclosed lower deck and an open upper deck. A stairway provides a means of accessing the upper deck from within the lower deck. Thus, a “double deck” bus was provided. Additional patents covering configurations for double deck buses have since been issued. Examples include U.S. Pat. No. 1,468,710 issued in 1923; U.S. Pat. No. 1,905,842 issued in 1932; U.S. Pat. No. 2,563,917 issued in 1944; and U.S. Pat. No. 3,971,455 issued in 1975. However, these double deck buses of the prior art limit the sightseeing ability of persons on the lower deck because of the presence of the upper deck and the relative lower position of the lower deck.

Recently, U.S. Pat. No. 6,336,676 issued in 2002. This patent discloses a double deck, dual use bus having a passenger compartment disposed in front of a container for carrying freight. A framework divides the passenger compartment from the freight compartment. In this arrangement, sightseeing opportunities to the passengers in the lower deck are restricted by both the upper deck above and the freight container in the rear.

U.S. Pat. No. 5,967,583 issued in 1999, and teaches a multi-level recreational vehicle. The vehicle has living spaces on at least two levels and an open air deck on the top. Use of the open air portion of the multi-level recreational vehicle is limited to times when the recreational vehicle is stationary, thus limiting the sightseeing opportunities to the occupants to a specific situation.

Therefore, a need exists for a single level tour bus having an elevated deck whereby substantially all passengers may view sights from above a transportation surface. A need also exists for an open air deck bus having a single elevated deck in order to provide equal sightseeing opportunities to all passengers on the bus while the bus is operated on a transportation surface. Certain embodiments of the invention described below and at least some of the corresponding claims will meet these needs.

### SUMMARY OF THE INVENTION

A multi-passenger bus is first provided. In one aspect, the bus includes a chassis, a driver's compartment at a forward portion of the chassis; an observation deck elevated above the chassis; a plurality of seats arranged on the observation deck; a stairwell; and a stairway. The stairway has a lower end disposed at a level below the chassis, and an upper end disposed at a level of the observation deck.

Preferably, the observation deck extends over the driver's compartment. Preferably, the seats are arranged on the deck in columns and rows for seating tourists. Preferably, the enclosure below the observation deck contains no seats for tour-passengers.

### BRIEF DESCRIPTION OF THE DRAWINGS

So that the manner in which the above recited features of the present invention can be better understood, certain drawings are appended hereto. It is to be noted, however, that the appended drawings illustrate only selected embodiments of the inventions and are therefore not to be considered limiting of scope, for the inventions may admit to other equally effective embodiments and applications.

FIG. 1 is a right side perspective view of the single elevated deck bus of the present invention, in one embodiment. The bus is parked on a transportation surface.

FIG. 2 is a right side plan view of the single elevated deck bus of the FIG. 1. Portions of the right side wall of the bus are broken away to expose internal details, including portions of an anterior support structure.

FIG. 3 presents a left front perspective view of the bus of FIG. 1. Portions of the left side wall of the bus are broken away to expose internal details, including a posterior support structure.

FIG. 4 is a perspective view of a portion of the enclosure within the bus of FIG. 1. Anterior and posterior support structures are seen, along with a connecting support structure therebetween and a central support structure.

FIG. 5 is a perspective view of the bus of FIG. 1, taken from a rear of the bus, and on a top surface or “observational deck.” A portion of a stairwell is seen. Also, a plurality of seats are shown from the rear.

FIG. 6 is another perspective view of the bus of FIG. 1 taken from the observational deck. In this view, the seats at the front portion of the bus are more clearly seen, along with a front cap of the bus.

FIG. 7 provides a perspective view of the bus of FIG. 1, taken from the front of the bus and on the observational deck. The plurality of seats are again shown, but from a front view.

### DETAILED DESCRIPTION

Definitions

As used herein, the terms “bus” or “tour bus” refer to any vehicle capable of transporting a plurality of passengers. Non-limiting examples include recreational vehicles, buses and trucks. The tour bus will have tires for mobility, but may be powered through any energy source including but not limited to electricity, solar rays, ethanol, hydrocarbon fuel or any hybrid fuel source.

The term “chassis” refers to the frame, suspension system, engine (or other power mechanism), and drive train of a vehicle.

The term “ticket” means any form of payment or proof of payment of a fare, such as a paper ticket, a token, a stamp, a magnetic credit (or debit) card or other form.

The term “money” refers to any form of currency or tokens, or a transaction using a credit card, debit card, charge card or pre-paid card.

### Description of Specific Embodiments

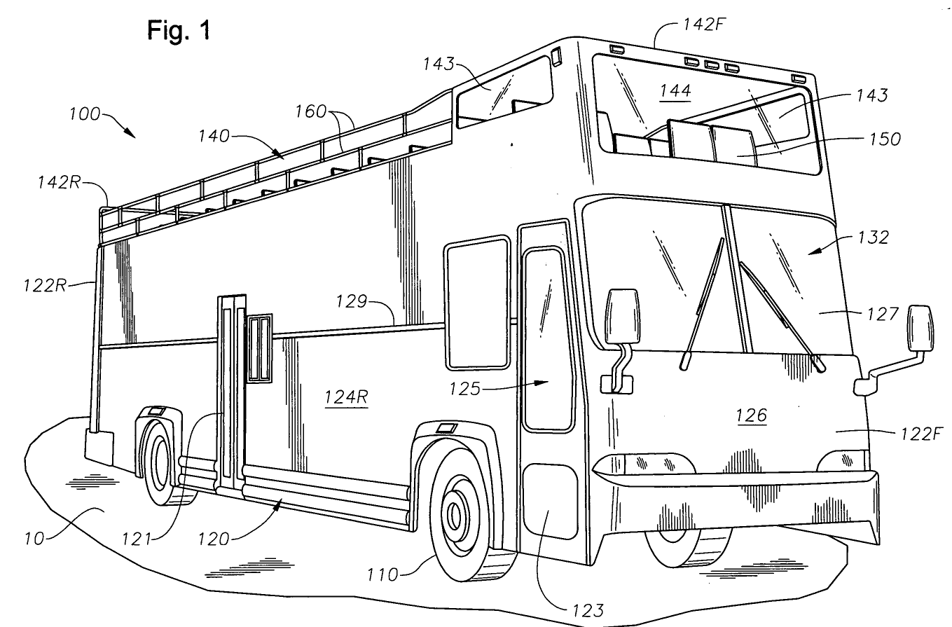

FIG. 1 presents a side view of a tour bus 100 in accordance with the present invention, in one embodiment. The tour bus 100 is parked on a transportation surface 10. In this view, the illustrative transportation surface 10 is a parking lot. The tour bus 100 is designed to transport a plurality of passengers over a street or highway or other such transportation surface 10, and from an elevated position. Tires 110 are shown for engaging the transportation surface 10.

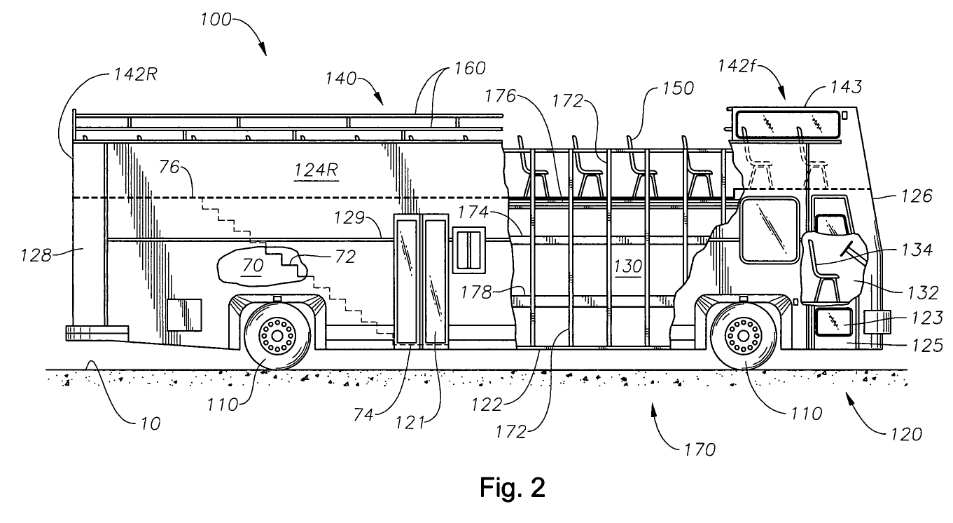

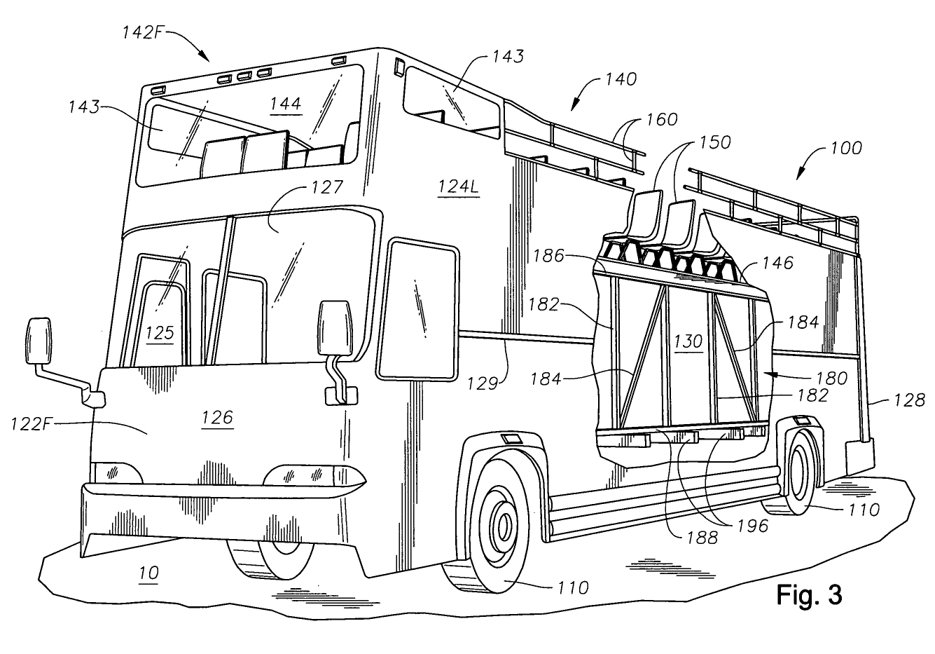

Certain features of the tour bus 100 are seen in FIG. 1. First, a right side wall 124R is provided. It is understood that an opposing left side wall 124L is also provided, which is shown in FIG. 3. Together, the right 124R and left 124L side walls form a lower enclosure 130 (seen in the cutaway views of FIGS. 2 and 3).

The tour bus 100 also has a pair of side doors 121, 123. Side door 121 provides ingress and egress for passengers, while side door 123 provides access to a driver's compartment 132 by a driver.

The tour bus 100 also has a front end 122F and a rear end 122R. A front end cap 126 and a front windshield 127 are provided at the front end 122F to enclose the driver's compartment 132. Other features are provided at the front 122F of the bus 100 but are not marked, such as rear view mirrors, a front bumper and a side driver's window. The driver's station 132 preferably includes a step lowered about ten inches and positioned to the right of a driver's seat 134 to allow sufficient room for the driver to enter and exit. A small platform behind the driver's station 132 is also constructed and raised about five or six inches from the floor in the driver's compartment 132.

The tour bus 100 also includes a chassis 120. As noted, the chassis refers to the base frame, suspension system, engine, and drive train of a vehicle. The base frame is shown at 122; however, the other listed parts are not shown. The base frame 122 may be fabricated from any material including but not limited to steel, aluminum (or aluminum alloy), woven graphite, molded plastic composites or other materials. The base frame 122 may include lightening holes (not shown) cut into it.

The chassis 120 supports the side walls 124R, 124L of the vehicle 100 as well as the front end cap 126, the front bumper and a rear end cap (shown at 128 in FIG. 2). The chassis 120 supports additional parts of the bus 100, as will be described further below.

The tour bus 100 also includes a single observation deck 140. The observation deck 140 is well elevated to afford paying tourists or other passengers a good view of surrounding items of historical or environmental interest. The observation deck 140 has a front end 142F and a rear end 142R. The front end 142F defines a front end cap having a wind screen 144. In the arrangement of FIG. 1, the wind screen 144 is a plexi-glass windshield. However, other materials such as a true glass or a poly-mesh may be utilized.

It is noted that the front end cap 142F wraps around the left 124L and right 124R sides of the bus 100 to include side wind screens 143. In the illustrated embodiment, the side windscreens 143 extend a distance substantially equal to the length of the driver's compartment 132. However, the windscreens 143 may alternatively extend from the front edge 142F to the rear end cap 128 of the bus 100.

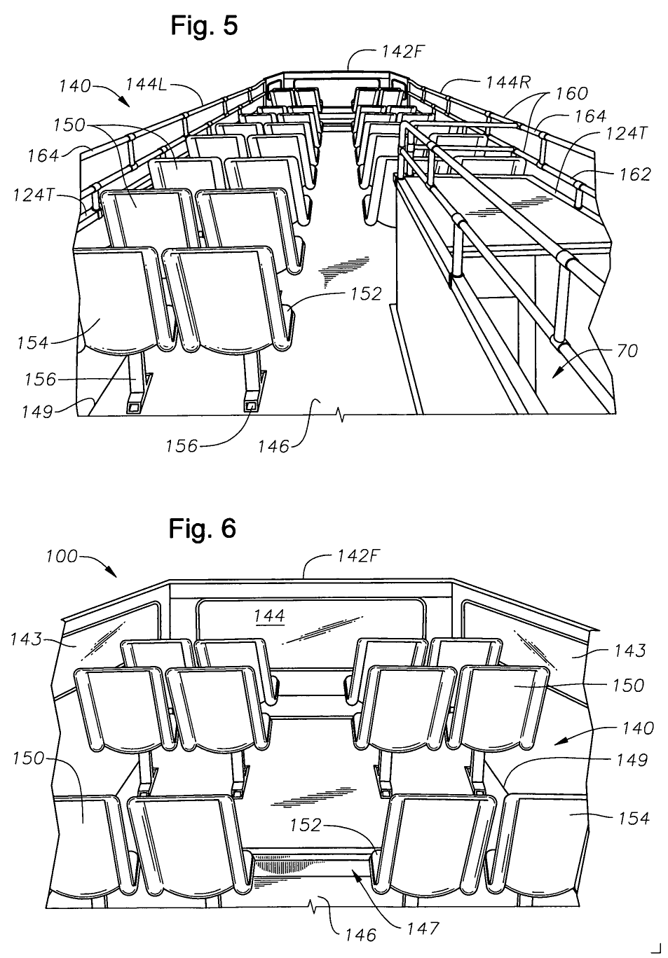

The observation deck 140 supports a plurality of seats 150. Only a few seats 150 are visible in the perspective view of FIG. 1. However, the seats 150 are more clearly seen in FIGS. 5-7, and are described in greater detail below in connection with those Figures.

Finally, it is noted from FIG. 1 that the observation deck 140 includes side rails 160. The side rails 160 are placed between the side wind screens 143 and the rear 142R of the observation deck 140. The side rails 160 serve as a safety aid for passengers on the observation deck 140.

Referring now to FIGS. 2 and 3, these figures provide cutaway views of the tour bus 100 of FIG. 1. FIG. 2 is a plan view of the single elevated deck bus 100 of the FIG. 1, taken from the right side 124R of the bus 100. FIG. 3 presents a left front perspective view of the bus 100 of FIG. 1. Portions of the side walls 124R, 124L of the bus 100 are broken away in the respective views to expose internal details described below. In FIG. 2, the right side wall 124R is cut away to expose the anterior support structure 170, while in FIG. 3 the left side wall 124L is cut away to expose the posterior support structure 180. These two support structures 170, 180 support the decking 140.

Certain features of the tour bus 100 from FIG. 1 are again visible in FIG. 2. These include tires 110, the passenger door 121, the driver's door 123, the driver's compartment 132, and the observation deck 140. In addition, both the front end cap 126 and the rear end cap 128 are shown. In addition, the right side wall 124R itself is seen. It is noted here that the right side wall 124R is preferably formed of an aluminum-based siding material which is glued to the anterior support structure 170 of the bus 100. The siding is preferably Alucabond® sheeting available in 35 foot long sheets up to 6 feet in width, thus allowing each side wall 124R, 124L to be covered with only two sheets of siding, the separate sheets joined together at the juncture thereof with a trim molding 129.

Certain features of the tour bus 100 from FIG. 1 are also visible in FIG. 3. These include tires 110, the front end cap 126, the driver's windshield 127, the passenger's front wind screen 144, the side wind screens 143, the observation deck 140, and railing 160. In addition, the plurality of seats 150 are seen along the observation deck 140.

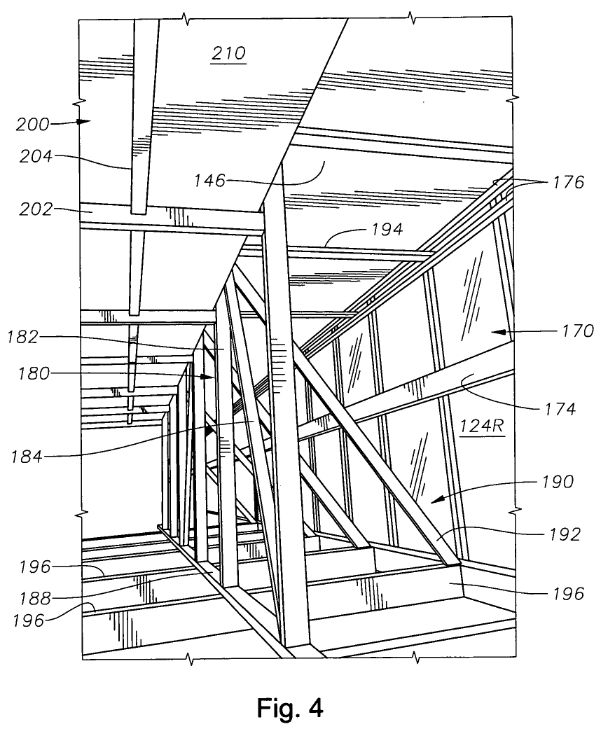

Referring again to FIG. 2, a portion of the anterior support structure 170 is exposed. The anterior support structure 170 includes upright beams 172 and a transverse horizontal beam 174. In addition, upper 176 and lower 178 beams are included. These beams 172, 174, 176, 178 may be joined by welded brackets or secured together by connector plates (not shown) or by suitable connectors such as nuts and bolts. The anterior support structure 170 is disposed along a longitudinal axis of the bus 100 along both the left 124L and right 124R side walls, separately. In one embodiment, lower portions of the upright beams 172 rest on the base frame 122 of the chassis 120. In an alternate aspect, lower horizontal beams 178 are connected to and supported by lower connecting beams 196 (seen in FIG. 4) using thick rubber bushings (not shown). A bolt (nor shown) is passed through each connecting beam 196, inserted rubber bushing and a corresponding mounting bracket. Nuts (also not shown) are then applied to the threaded open ends (not shown) of each bolt and tightened against the underside of the mounting brackets, thus tying the lower beams 196 to the chassis 120.

Outer faces of the beams 172, 174, 176, 178 of the anterior support structure 170 are connected to and support the siding that forms the side walls 124R, 124L. Typically, an adhesive is used for the connection. The side walls 124R, 124L extend above the flooring (seen at 146 in FIG. 5) of the observational deck 140.

Referring next to FIG. 3, a portion of the posterior support structure 180 is seen. The posterior support structure 180 includes upright beams 182 connected in some instances by angle beams 184. Transverse horizontal upper 186 and lower 188 horizontal beams are also included. The beams 182, 184, 186, 188 of the posterior support structure 180 may likewise be joined by welded brackets or secured together by connector plates or other suitable connector (not shown). As with the anterior support structure 170, the posterior support structure 180 is disposed along a longitudinal axis of the bus 100, but just interior to the anterior support structure 170.

The anterior 170 and posterior 180 support structures may be joined together by an intermediate connecting structure 190 for additional support. FIG. 4 provides an additional view of the anterior 170 and posterior 180 support structures, along with the intermediate connecting structure 190. FIG. 4 is a perspective view from within the enclosure 130 of the bus 100 of FIG. 1, in one embodiment. The view is looking forward towards the front end 122F of the bus 100.

The connecting structure 190 includes lateral beams 192. It may also include upper 194 and lower 196 horizontal beams. The beams 192, 194, 196 of the connecting structure 190 serve to stabilize the anterior 170 and posterior 180 support structures within the bus 100. In addition, the upper beams 194 of the connecting structure 190 support the decking 146 of the deck 140 on the left and right sides. Portions of the posterior 180 and connecting 190 structures are cut out along the right side wall 124R to create space for the passenger door 121 and for a stairwell 70 of the bus 100, described below. The cutout on the right side 124R of the bus 100 is preferably disposed ahead of the rear wheels.

Also of interest from FIG. 4, the upper beams 194 of the connecting structure 190 are shown immediately under the decking 146 of the deck 140 along the right side. The right side wall 124R is seen secured to the anterior support structure 170.

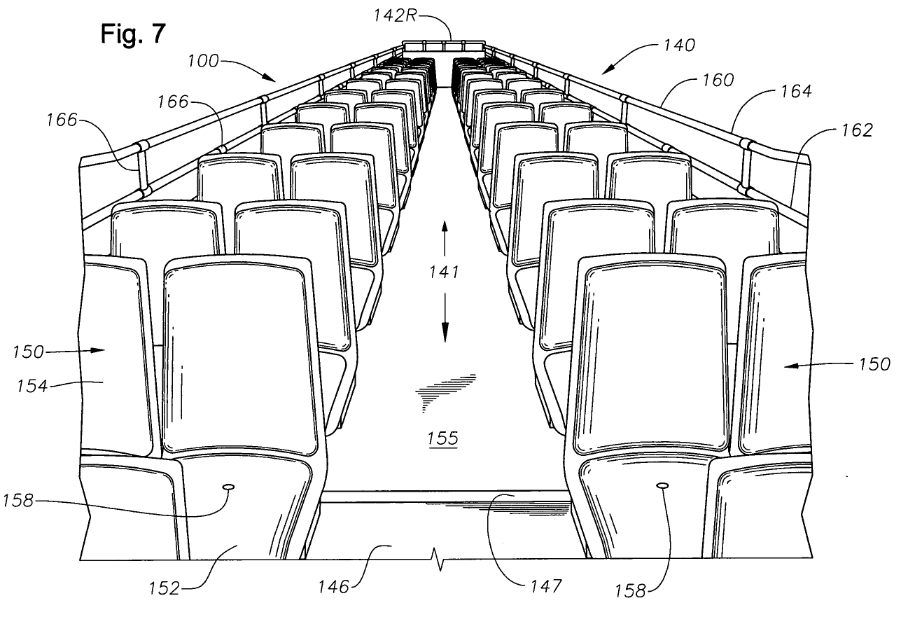

A central support structure 200 is also seen in FIG. 4. The central support structure 200 includes transverse 202 and longitudinal 204 beams. These beams 202, 204 support a central portion of the decking 146 from within the enclosure 130. In the embodiment of FIG. 1, the central portion of the decking serves as a walkway, indicated as 155 in FIG. 7. Underneath the decking, a drop-down channel 210 may be provided to house duct work, electrical wiring, or other materials. The drop-down channel 210 is seen in FIG. 4, but not shown in the cut-a-way view of FIG. 3. The transverse beams 202 are preferably joined to the upright beams 182 of the posterior support structure 180.

The central support structure 200 is disposed along the longitudinal axis of the bus 100. Preferably, the central support structure 200 is supported at a height of approximately 8 feet above the transportation surface 10. The central support structure 200 provides central support to the observation deck 140. In contrast, the upper beam 176 of the anterior support structure 170 extends upward to a height of about 7 feet, 10 inches above the transportation surface 10. This is slightly lower than the central support 200 for the flooring 146. In this way, the flooring 146 is crowned to facilitate runoff of water towards the side walls 124L, 124R of the bus 100.

Referring back to FIG. 2, additional features of the bus 100 are seen from cut-away portions in the right side wall 124R. The lower enclosure area 130 is visible. The lower enclosure area 130 is generally defined by the side walls 124R, 124L, the base frame 122 and the flooring 146 of the deck 140. The forward portion 122F of the lower enclosure area 130 includes the driver's compartment 132. The driver's seat 134 is seen within the driver's compartment 132 for receiving a driver or chauffeur. The driver's compartment 132 will also include operating apparatus such as the steering wheel, braking and accelerating pedals, etc. (not shown). Preferably, the driver's compartment 132 is placed as low as possible to operating surface 10 to allow the driver to readily see out of the front 122F of the tour bus 100.

The lower enclosure area 130 also includes a stairwell 70. In the illustrated embodiment, the stairwell 70 is positioned towards the rear 122R of the bus 100. The stairwell 70 is dimensioned to receive a stairway 72 comprising steps. A bottom step 74 and an upper step 76 are seen. The lower step 74 is secured to the chassis 120, while the upper end 76 is secured to and terminates at the flooring 146 of the elevated deck 140. The stairwell 70 defines an opening within the flooring 46 of the elevated deck 140. In one embodiment, there are a total of eight, ten-inch steps and one, six-inch step provided. In one aspect, the bottom step 74 extends below the chassis 120.

FIG. 5 is a perspective view of the bus 100 of FIG. 1, taken from a rear of the bus 100, and on the observational deck 140. The view is looking forward towards the front end 142f of the deck 140. The stairwell 70 is seen extending through the decking 146 of the deck 140. The observation deck 140 is elevated above the chassis 120. The observation deck 140 has a front portion 142F and a rear portion (seen at 142R in FIG. 7). The front portion 142F ideally extends above the driver's compartment 132. The observation deck 140 also has a left side edge 144L and a right side edge 144R.

FIG. 6 provides another perspective view of the bus 100 of FIG. 5, taken again from the observational deck 140. Here, the view is taken in closer proximity to the front 142F of the deck 140. The passenger's front 144 and side 143 windscreens are seen at the front 142F of the deck 140 is seen. Preferably, the windscreens 144, 143 are integral to the front end cap 126 of the bus 100.

It is observed from FIGS. 5 and 6 that the flooring 146 at the front 142F of the bus 100 is raised relative to the flooring 146 of the rest of the deck 140. This is done to accommodate head room and operating room of the driver within the driver's compartment 132. A step 147 is shown leading to the front 142F of the bus 100.

FIG. 7 provides a perspective view of the bus 100 of FIG. 1, taken again on the observational deck 140. As compared to FIGS. 5 and 6, this view is seen from the front 142F of the bus 100 looking towards the rear 142R.

In each of FIGS. 5, 6 and 7, the plurality of seats 150 are seen. Each seat 150 has a seating portion 152 and a back 154. Further, each seat 150 has a base 156. Preferably, the seats 150 are fabricated from a waterproof material such as a molded thermoplastic material. A cushioning material is also preferably utilized within or on the thermoplastic material. Each seat 150 may include a drain hole 158 disposed through the seating portion 152 to channel any moisture from the seating portion 152 to the flooring 146 surface forming the elevated deck 140. One source of suitable seats 150 is the Friedman manufacturing company out of Indiana.

It should be added that the seats 150 may be individual chairs, or they may be bench- or pew-type seats. The seats 150 may be arranged in rows and columns, or they may be staggered. Preferably, the seats 150 are arranged in two columns divided by a walkway 155 as shown best in FIG. 7. The walkway 155 may be centrally located, disposed closer to one side of the elevated observation deck 140, or along one side of the deck 140.

As noted, the flooring 146 for the elevated observation deck 140 is preferably crowned by elevating a longitudinally central portion 141. The relief provided by the crowned deck 140 allows water to run to opposing side edges 149 of the decking 140. Preferably, drain holes 145 are disposed through the side edges 149 to receive water. The drain holes (not shown) are in fluid communication with drain pipes (also not shown) along the side walls 124R, 124L to direct runoff water to the surface 10 upon which the bus 100 is operated.

The flooring 146 for the observation deck 140 is fabricated from a sturdy and water resistant material. In one embodiment, the flooring 140 defines a heavy plywood treated with a waterproofing epoxy cement. The flooring 146 is further overlaid with rubberized decking material. The rubberized decking material may be of the paint-on or spray-on type, or may even be a separate, preformed layer that is unrolled over the treated plywood. One source for rubberized flooring material is the Congoleum Corporation of Mercerville, N.J., commonly sold under the trade name Congoleum®. Preferably, the flooring 146 includes raised portions and depressed areas to provide a safe and comfortable walking surface. The central portion 141 of the flooring 146 is supported by the central support structure 200, while the opposing edges 149 of the flooring 146 are supported by the anterior 170 and posterior 180 support structures, and the upper beam 194 of the connecting structure 190. Together, support structures 170, 180, 190 and 200 form one embodiment for a structural support system for supporting the observational deck 140.

It is preferred that the flooring 146 be positioned about 7.5 feet to 10 feet above the transportation surface 10. This height is sufficiently elevated to enable passengers to view surrounding sights during transportation, but low enough to limit moment of the vehicle 100 and avoiding tipping during turns. Preferably, the flooring 146 is eight feet above the transportation surface 10, except for the forward portion 142F above the driver's compartment 132, which is preferably 8.5 feet above the transportation surface 10.

Referring again to FIGS. 5 and 7, these views from the observation deck 140 best show the side rails 160 of the bus 100. In the demonstrated arrangement, the side rails 160 include separate lower 162 and upper 164 rails, supported by vertical bars 166. Some of the vertical bars 166 are secured to the left 124L and right 124R side walls along respective top 124T surfaces. The lower 162 and upper 164 rails serve as safety railing. Preferably, the upper bar 164 is disposed about six inches above lower bar 162, the space therebetween being sufficiently small to prevent a small child from passing between bars 162, 164.

The above described drawings disclose a tour bus 100 having a single, elevated deck 140. The height of the deck 140 permits all passengers to view surrounding sights from a common seating area. At the same time, the height of the deck 140 is not so high as to create a danger of causing the bus 100 to tip when the driver turns a corner at a reasonable, sight-seeing speed such as 10 to 40 miles per hour.

It is noted that the bus 100 of FIG. 1 does not include a roof. However, an additional novel feature of the bus 100 would include a removable roof.

A method for sight-seeing is also provided herein. The method first involves the provision of a bus having a single, elevated observation deck, such as the bus 100 described above. Next, tickets are sold to a plurality of passengers. Tickets may be sold at a booth or station external to the bus, or tickets may be sold through a ticket taker platform on the bus 100. Such a platform may include one or more display cases along a recessed wall (not shown) adjacent the ticket taker platform which holds brochures advertising sight-seeing tours of the company operating or owning the bus. Where the bus 100 operates over a defined route on a regular basis disembarking and embarking passengers at defined locations, the ticket taker platform may house an automatic ticket taking device which accepts either coins, currency, credit/debit cards or tokens which permits embarking of passengers paying the proper fare. The automatic ticket taking device would likely have a stairway bar (not shown) to deny access to the observation deck to potential passengers who have not provided the proper fare for the tour.

One preferred embodiment of the sight-seeing method has passengers purchasing a multiple trip pass which is read by the automatic ticket taking device, thus allowing the ticketed passenger to periodically embark and disembark at desired locations along the tour route within a defined time period. In one aspect, the multiple trip pass is a day pass. In another embodiment, a passenger may purchase a multiple day/multiple route pass allowing the passenger to avail himself/herself with all the tours available to the company operating multiple single elevated deck busses over multiple routes.

After paying the proper fare, the passengers enter the bus 100 through a door such as passenger door 121. From there, the passengers move through a stairwell such as stairwell 70 onto a common elevated observation deck, such as deck 140. The observation deck 140 is elevated to a height of at least 6 feet above the transportation surface 10, and preferably at least 7.5 feet.

The passengers seat themselves in respective seats, such as seats 150. The bus 100 is operated by a driver, who drives the passengers along a selected transportation surface 10 to provide sight-seeing services. It is noted that either a ticket taker or the driver may also function as a tour guide after embarking all passengers at a particular stop by describing sites to the passengers as the bus approaches the sites over a loud speaker system.

The bus 100 may optionally house an elevator (not shown) to raise physically handicapped persons to the single elevated observation deck 140. For instance, the ticket taker may step aside while boarding a physically handicapped person, operate the elevator to raise the handicapped person to the observation deck 140, lower the elevator after the handicapped person has disembarked, and resume the function as ticket taker.

While the present inventions have been described with reference to the above described preferred embodiments, it should be noted that various other embodiments and modifications may be made without departing from the spirit of the invention. Therefore, the embodiments described herein and the drawings appended hereto are merely illustrative of the features of the invention and should not be construed to be the only variants thereof nor limited thereto.

I claim:

1. A multi-passenger tour bus for operating on a transportation surface, comprising:
a chassis;
a single observation deck elevated above the chassis having a height of at least six feet above the transportation surface;
a plurality of seats arranged on the observation deck;
a structural support system for supporting the observation deck; and
a stairway having a lower end proximate the chassis, and an upper end terminating proximate a level of the observation deck.

2. The tour bus of claim 1, wherein the plurality of seats are arranged in rows and columns.

3. The tour bus of claim 1, further comprising a driver's compartment at a forward portion of the chassis, and wherein the observation deck includes a forward portion extending over the driver's compartment.

4. The tour bus of claim 3, wherein the observation deck comprises a step and a raised surface above the driver's compartment.

5. The tour bus of claim 1, further comprising:
left and right side walls; and
a lower enclosure defined in part by the left and right side walls and a flooring of the observation deck.

6. The tour bus of claim 5, further comprising:
a stairwell within the enclosure for receiving the stairway.

7. The tour bus of claim 1, wherein the observation deck further comprises:
a flooring for supporting the plurality of seats, the flooring being crowned along a longitudinal axis to permit runoff;
drain holes along opposing side edges of the flooring to receive runoff;
a front wind screen; and
an opening within the flooring for receiving the stairway.

8. The tour bus of claim 1, wherein the structural support system comprises:
a central support structure disposed along a longitudinal axis of the bus approximately central to the bus; and
left and right side support walls.

9. The tour bus of claim 8, wherein the structural support system further comprises:
an anterior support structure on opposing sides of the bus and upon which the left and right side walls, respectively, are connected;
a posterior support structure within the anterior support structure along the opposing sides of the bus; and
an intermediate connecting support structure connecting the anterior and posterior support structures.

10. The tour bus of claim 9, wherein a height of the central support structure is greater than a height of each of the left and right anterior support structures so as to provide a crown along a longitudinal axis of the observation deck.

11. A method for conducting sightseeing services, comprising the steps of:
providing a multi-passenger tour bus for operating on a transportation surface, the tour bus comprising:
a chassis,
a single observation deck elevated above the chassis having a height of at least 6 feet above the transportation surface,
a plurality of seats arranged on the observation deck,
a structural support system for supporting the observation deck, and
a stairway having a lower end supported by the chassis, and an upper end terminating proximate a level of the observation deck;
selling tickets to a plurality of passengers;
directing the plurality of passengers to the observation deck; and
operating the bus.

12. The method of claim 11, wherein the bus further comprises:
left and right side walls;
a lower enclosure defined in part by the left and right side walls and a flooring of the observation deck; and
a stairwell within the enclosure for receiving the stairway.

13. The method of claim 11, wherein the observation deck further comprises:
a flooring for supporting a plurality of seats, the flooring being crowned along a longitudinal axis to permit runoff; and
an opening for receiving the stairway.

14. The method of claim 11, wherein the step of selling tickets comprises:
providing an automatic ticket taker which dispenses a ticket upon receipt of money.
